(19) United States
(12) Patent Application Publication
(10) Pub. No.: US 2011/0320944 A1
(43) Pub. Date: Dec. 29, 2011

(54) SYSTEMS, METHODS, AND APPARATUSES FOR GENERATING AN INTEGRATED USER INTERFACE

(75) Inventors: Jari Nikara, Lempaala (FI); Mika Pesonen, Tampere (FI); Eero Aho, Tampere (FI)

(73) Assignee: Nokia Corporation

(21) Appl. No.: 12/826,022

(22) Filed: Jun. 29, 2010

(51) Int. Cl. G06F 3/048; G06F 15/16

(52) U.S. Cl. 715/716; 709/203; 715/790

(57) ABSTRACT

Methods and apparatuses are provided for generating an integrated user interface. A method may include obtaining, in a client apparatus, first user interface information generated by a client application residing on the client apparatus. The method may further include obtaining, in the client apparatus, second user interface information generated by a server application residing on a remote server apparatus. The method may additionally include combining the first and second user interface information to generate an integrated application user interface. Corresponding apparatuses are also provided.

### TECHNOLOGICAL FIELD

Embodiments of the present invention relate generally to data processing technology and, more particularly, relate to systems, methods, and apparatuses for generating an integrated user interface.

### BACKGROUND

The modern computing era has brought about a tremendous expansion in computing power as well as increased affordability of computing devices. This expansion in computing power has led to a reduction in the size of computing devices and given rise to a new generation of mobile devices that are capable of performing functionality that only a few years ago required processing power that could be provided only by the most advanced desktop computers. Consequently, mobile computing devices having a small form factor are becoming increasingly ubiquitous and are used for a wide variety of purposes.

For example, many mobile computing devices are now configured with versatile hardware functionality, such as built-in digital cameras, global positioning system service, and/or the like. Accordingly, users may use their multi-function mobile computing devices for a vast array of purposes. However, in spite of the expansion in computing power of mobile computing devices, many mobile computing devices continue to have relatively limited processing power such that some mobile computing devices may not be capable of implementing feature rich applications that are relatively processor-intensive. Similarly, some mobile computing devices are impacted by limited battery life and limited storage space. In this regard, mobile computing devices may not be able to be able to fully take advantage of built-in hardware functionality due to resource limitations inherent to mobile platforms.

### BRIEF SUMMARY

The systems, methods, apparatuses, and computer program products provided in accordance with example embodiments of the invention may provide several advantages to computing devices, network service providers, and computing device users. Some example systems, methods, apparatuses, and computer program products described herein facilitate generation of an integrated user interface from user interface information provided by two or more applications running in parallel and distributed between a client apparatus and a server apparatus. In this regard, according to some example embodiments, a client application residing on a client apparatus may provide a first portion of user interface information and a server application running on a server apparatus may provide a second portion of user interface information. The first and second portions of user interface information may be combined in accordance with some example embodiments into a single integrated user interface that is output to a user of the client apparatus to provide a singular application user experience to the user. Accordingly, by some example embodiments, at least some of the processing and/or other resource requirements needed for generating data providing an application user interface for a user may be offloaded from a potentially resource limited client apparatus to a remote server apparatus. Thus, computing devices implementing some example embodiments may benefit due to a reduced resource usage burden. In this regard, some example embodiments may provide better load balancing between a client apparatus and a server apparatus.

Further, network service providers may benefit from some example embodiments due to an enhanced ability to provide feature rich applications and services to subscribers or other users that are not strictly limited by limitations of hardware platforms used by users. Additionally, users may benefit from some example embodiments through usage and enjoyment of feature rich applications that may not be possible without the distributed nature of some example embodiments. Further, some example embodiments may result in the creation of new applications and/or application experiences for end users due to the combination of user interface information provided by a client application with user interface information provided by a server application. In this regard, the user interface experienced by an end user may be a unique user interface that is distinct both from the client application and from the server application that may have generated portions of the user interface experienced by the end user.

In a first example embodiment, a method is provided, which comprises obtaining, in a client apparatus, first user interface information generated by a client application residing on the client apparatus. The method of this example embodiment further comprises obtaining, in the client apparatus, second user interface information generated by a server application residing on a remote server apparatus. The method of this example embodiment additionally comprises combining the first and second user interface information to generate an integrated application user interface.

In another example embodiment, an apparatus is provided. The apparatus of this example embodiment comprises at least one processor and at least one memory storing computer program code, wherein the at least one memory and stored computer program code are configured, with the at least one processor, to cause the apparatus to at least obtain first user interface information generated by a client application residing on the apparatus. The at least one memory and stored computer program code are configured, with the at least one processor, to further cause the apparatus of this example embodiment to obtain second user interface information generated by a server application residing on a remote server apparatus. The at least one memory and stored computer program code are configured, with the at least one processor, to additionally cause the apparatus of this example embodiment to combine the first and second user interface information to generate an integrated application user interface.

In another example embodiment, a computer program product is provided. The computer program product of this embodiment includes at least one computer-readable storage medium having computer-readable program instructions stored therein. The program instructions of this example embodiment comprise program instructions configured to obtain, in a client apparatus, first user interface information generated by a client application residing on the client apparatus. The program instructions of this example embodiment further comprise program instructions configured to obtain, in the client apparatus, second user interface information generated by a server application residing on a remote server apparatus. The program instructions of this example embodiment also comprise program instructions configured to combine the first and second user interface information to generate an integrated application user interface.

In another example embodiment, an apparatus is provided that comprises means for obtaining first user interface information generated by a client application residing on the apparatus. The apparatus of this example embodiment further comprises means for obtaining second user interface information generated by a server application residing on a remote server apparatus. The apparatus of this example embodiment additionally comprises means for combining the first and second user interface information to generate an integrated application user interface.

The above summary is provided merely for purposes of summarizing some example embodiments of the invention so as to provide a basic understanding of some aspects of the invention. Accordingly, it will be appreciated that the above described example embodiments are merely examples and should not be construed to narrow the scope or spirit of the invention in any way. It will be appreciated that the scope of the invention encompasses many potential embodiments, some of which will be further described below, in addition to those here summarized.

### BRIEF DESCRIPTION OF THE DRAWING(S)

Having thus described embodiments of the invention in general terms, reference will now be made to the accompanying drawings, which are not necessarily drawn to scale, and wherein:

FIG. 1 illustrates a block diagram of a system for generating an integrated user interface according to an example embodiment of the invention;

FIG. 2 is a schematic block diagram of a mobile terminal according to an example embodiment of the invention;

FIG. 3 illustrates a block diagram of a client apparatus for generating an integrated user interface according to an example embodiment of the invention;

FIG. 4 illustrates a block diagram of a server apparatus for facilitating generation of an integrated user interface according to an example embodiment of the invention;

FIG. 5 illustrates an example architecture for generating an integrated user interface according to an example embodiment of the invention;

FIG. 6 illustrates an example architecture for generating an integrated user interface according to an example embodiment of the invention;

FIG. 7 illustrates generation of an object recognition user interface according to an example embodiment of the invention;

FIG. 8 illustrates a flowchart according to an example method for generating an integrated user interface according to an example embodiment of the invention;

FIG. 9 illustrates a flowchart according to an example method for generating an integrated user interface according to an example embodiment of the invention; and

FIG. 10 illustrates a flowchart according to an example method for facilitating generation of an integrated user interface according to an example embodiment of the invention.

### DETAILED DESCRIPTION

Some embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information” and similar terms may be used interchangeably to refer to data capable of being transmitted, received and/or stored in accordance with embodiments of the present invention. Thus, use of any such terms should not be taken to limit the spirit and scope of embodiments of the present invention. Further, where a computing device is described herein to receive data from another computing device, it will be appreciated that the data may be received directly from the another computing device or may be received indirectly via one or more intermediary computing devices, such as, for example, one or more servers, relays, routers, network access points, base stations, and/or the like. As defined herein a “computer-readable storage medium,” which refers to a non-transitory, physical storage medium (e.g., volatile or non-volatile memory device), can be differentiated from a “computer-readable transmission medium,” which refers to an electromagnetic signal.

Additionally, as used herein, the term ‘circuitry’ refers to (a) hardware-only circuit implementations (for example, implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

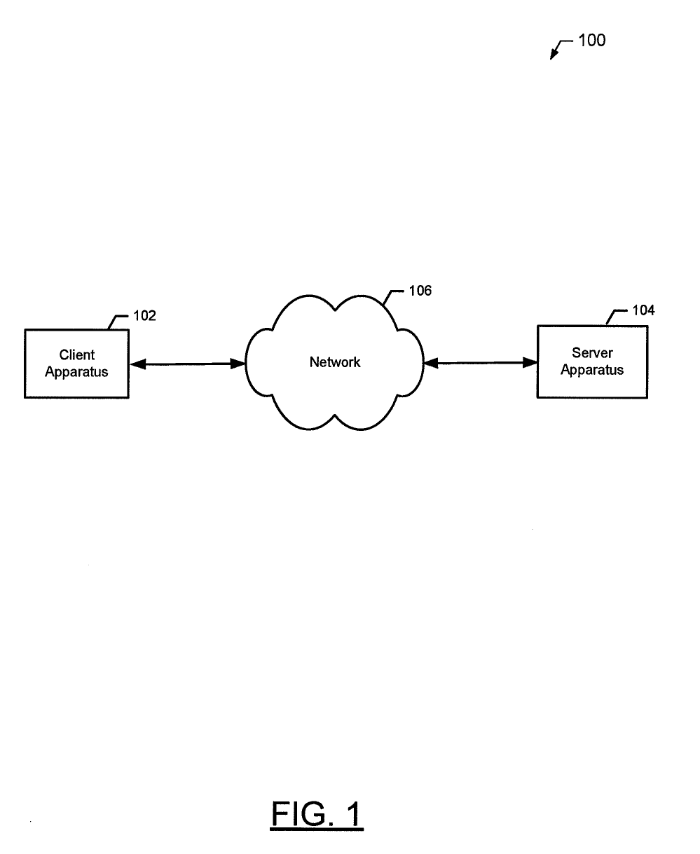

Referring now to FIG. 1, FIG. 1 illustrates a block diagram of a system 100 for generating an integrated user interface according to an example embodiment of the present invention. It will be appreciated that the system 100 as well as the illustrations in other figures are each provided as an example of one embodiment of the invention and should not be construed to narrow the scope or spirit of the invention in any way. In this regard, the scope of the disclosure encompasses many potential embodiments in addition to those illustrated and described herein. As such, while FIG. 1 illustrates one example of a configuration of a system for generating an integrated user interface, numerous other configurations may also be used to implement embodiments of the present invention.

In at least some embodiments, the system 100 includes a server apparatus 104 and a client apparatus 102. The server apparatus 104 may be in communication with one or more client apparatuses 102 over the network 106. The network 106 may comprise a wireless network (e.g., a cellular network, wireless local area network, wireless personal area network, wireless metropolitan area network, and/or the like), a wireline network, or some combination thereof, and in some embodiments comprises at least a portion of the interne.

The server apparatus 104 may be embodied as one or more servers, a server cluster, a cloud computing infrastructure, one or more desktop computers, one or more laptop computers, one or more mobile computers, one or more network nodes, multiple computing devices in communication with each other, any combination thereof, and/or the like. In this regard, the server apparatus 104 may comprise any computing device or plurality of computing devices configured to provide user interface information to a client apparatus 102 over the network 106 as described herein.

The client apparatus 102 may be embodied as any computing device, such as, for example, a desktop computer, laptop computer, mobile terminal, mobile computer, mobile phone, mobile communication device, game device, digital camera/camcorder, audio/video player, television device, radio receiver, digital video recorder, positioning device, wrist watch, portable digital assistant (PDA), any combination thereof, and/or the like. In this regard, the client apparatus 102 may be embodied as any computing device configured to communicate and exchange data with the server apparatus 104 over the network 106, as will be described further herein below.

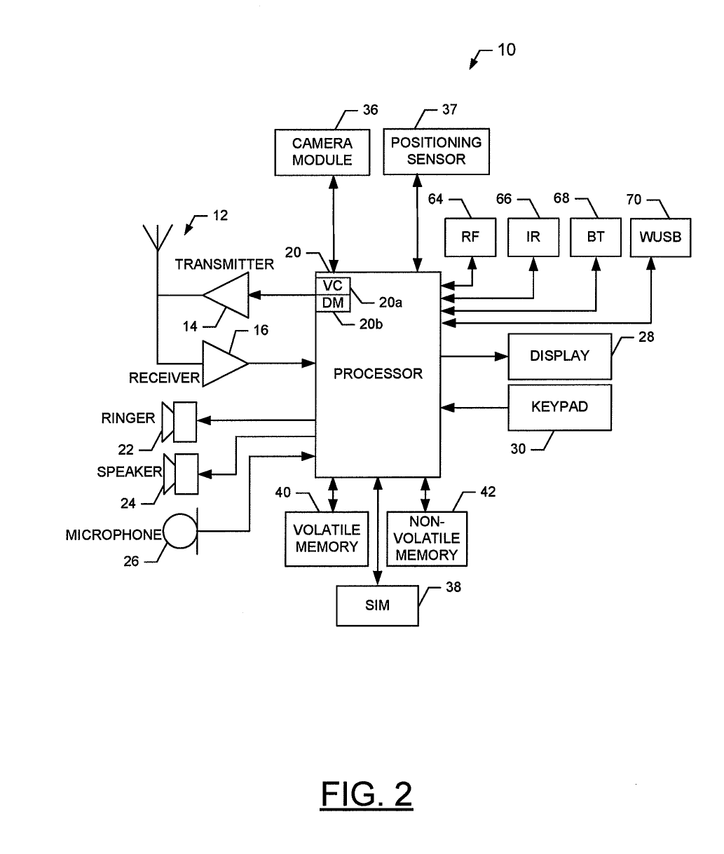

In an example embodiment, the client apparatus 102 is embodied as a mobile terminal, such as that illustrated in FIG. 2. In this regard, FIG. 2 illustrates a block diagram of a mobile terminal 10 representative of one embodiment of a client apparatus 102 in accordance with some example embodiments. It should be understood, however, that the mobile terminal 10 illustrated and hereinafter described is merely illustrative of one type of client apparatus 102 that may implement and/or benefit from disclosed embodiments and, therefore, should not be taken to limit the scope of the present invention. While several embodiments of the electronic device are illustrated and will be hereinafter described for purposes of example, other types of electronic devices, such as mobile telephones, mobile computers, portable digital assistants (PDAs), pagers, laptop computers, desktop computers, gaming devices, televisions, and other types of electronic systems, may employ embodiments of the present invention.

As shown, the mobile terminal 10 may include an antenna 12 (or multiple antennas 12) in communication with a transmitter 14 and a receiver 16. The mobile terminal 10 may also include a processor 20 configured to provide signals to and receive signals from the transmitter and receiver, respectively. The processor 20 may, for example, be embodied as various means including circuitry, one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. Accordingly, although illustrated in FIG. 2 as a single processor, in some embodiments the processor 20 comprises a plurality of processors. These signals sent and received by the processor 20 may include signaling information in accordance with an air interface standard of an applicable cellular system, and/or any number of different wireline or wireless networking techniques, comprising but not limited to Wireless-Fidelity, Wi-Fi™ techniques, wireless local access network (WLAN) techniques such as Institute of Electrical and Electronics Engineers (IEEE) 802.11, 802.16, and/or the like. In addition, these signals may include speech data, user generated data, user requested data, and/or the like. In this regard, the mobile terminal may be capable of operating with one or more air interface standards, communication protocols, modulation types, access types, and/or the like. More particularly, the mobile terminal may be capable of operating in accordance with various first generation (1G), second generation (2G), 2.5G, third-generation (3G) communication protocols, fourth-generation (4G) communication protocols, Internet Protocol Multimedia Subsystem (IMS) communication protocols (for example, session initiation protocol (SIP)), and/or the like. For example, the mobile terminal may be capable of operating in accordance with 2G wireless communication protocols IS-136 (Time Division Multiple Access (TDMA)), Global System for Mobile communications (GSM), IS-95 (Code Division Multiple Access (CDMA)), and/or the like. Also, for example, the mobile terminal may be capable of operating in accordance with 2.5G wireless communication protocols General Packet Radio Service (GPRS), Enhanced Data GSM Environment (EDGE), and/or the like. Further, for example, the mobile terminal may be capable of operating in accordance with 3G wireless communication protocols such as Universal Mobile Telecommunications System (UMTS), Code Division Multiple Access 2000 (CDMA2000), Wideband Code Division Multiple Access (WCDMA), Time Division-Synchronous Code Division Multiple Access (TD-SCDMA), and/or the like. The mobile terminal may be additionally capable of operating in accordance with 3.9G wireless communication protocols such as Long Term Evolution (LTE) or Evolved Universal Terrestrial Radio Access Network (E-UTRAN) and/or the like. Additionally, for example, the mobile terminal may be capable of operating in accordance with fourth-generation (4G) wireless communication protocols and/or the like as well as similar wireless communication protocols that may be developed in the future.

Some Narrow-band Advanced Mobile Phone System (NAMPS), as well as Total Access Communication System (TACS), mobile terminals may also benefit from embodiments of this invention, as should dual or higher mode phones (for example, digital/analog or TDMA/CDMA/analog phones). Additionally, the mobile terminal 10 may be capable of operating according to Wi-Fi™ protocols, Worldwide Interoperability for Microwave Access (WiMAX) protocols, and/or the like.

It is understood that the processor 20 may comprise circuitry for implementing audio/video and logic functions of the mobile terminal 10. For example, the processor 20 may comprise a digital signal processor device, a microprocessor device, an analog-to-digital converter, a digital-to-analog converter, and/or the like. Control and signal processing functions of the mobile terminal may be allocated between these devices according to their respective capabilities. The processor may additionally comprise an internal voice coder (VC) 20a, an internal data modem (DM) 20b, and/or the like. Further, the processor may comprise functionality to operate one or more software programs, which may be stored in memory. For example, the processor 20 may be capable of operating a connectivity program, such as a web browser. The connectivity program may allow the mobile terminal 10 to transmit and receive web content, such as location-based content, according to a protocol, such as Wireless Application Protocol (WAP), hypertext transfer protocol (HTTP), and/or the like. The mobile terminal 10 may be capable of using a Transmission Control Protocol/Internet Protocol (TCP/IP) to transmit and receive web content across the interne or other networks.

The mobile terminal 10 may also comprise a user interface including, for example, an earphone or speaker 24, a ringer 22, a microphone 26, a display 28, a user input interface, and/or the like, which may be operationally coupled to the processor 20. In this regard, the processor 20 may comprise user interface circuitry configured to control at least some functions of one or more elements of the user interface, such as, for example, the speaker 24, the ringer 22, the microphone 26, the display 28, and/or the like. The processor 20 and/or user interface circuitry comprising the processor 20 may be configured to control one or more functions of one or more elements of the user interface through computer program instructions (for example, software and/or firmware) stored on a memory accessible to the processor 20 (for example, volatile memory 40, non-volatile memory 42, and/or the like). Although not shown, the mobile terminal may comprise a battery for powering various circuits related to the mobile terminal, for example, a circuit to provide mechanical vibration as a detectable output. The user input interface may comprise devices allowing the mobile terminal to receive data, such as a keypad 30, a touch display (not shown), a joystick (not shown), and/or other input device. In embodiments including a keypad, the keypad may comprise numeric (0-9) and related keys (#, *), and/or other keys for operating the mobile terminal.

As shown in FIG. 2, the mobile terminal 10 may also include one or more means for sharing and/or obtaining data. For example, the mobile terminal may comprise a short-range radio frequency (RF) transceiver and/or interrogator 64 so data may be shared with and/or obtained from electronic devices in accordance with RF techniques. The mobile terminal may comprise other short-range transceivers, such as, for example, an infrared (IR) transceiver 66, a Bluetooth™ (BT) transceiver 68 operating using Bluetooth™ brand wireless technology developed by the Bluetooth™ Special Interest Group, a wireless universal serial bus (USB) transceiver 70 and/or the like. The Bluetooth™ transceiver 68 may be capable of operating according to ultra-low power Bluetooth™ technology (for example, Wibree™) radio standards. In this regard, the mobile terminal 10 and, in particular, the short-range transceiver may be capable of transmitting data to and/or receiving data from electronic devices within a proximity of the mobile terminal, such as within 10 meters, for example. Although not shown, the mobile terminal may be capable of transmitting and/or receiving data from electronic devices according to various wireless networking techniques, including Wireless Fidelity, Wi-Fi™ techniques, WLAN techniques such as IEEE 802.11 techniques, IEEE 802.15 techniques, IEEE 802.16 techniques, and/or the like.

In an example embodiment, the mobile terminal 10 may include a media capturing element, such as a camera, video and/or audio module, in communication with the processor 20. The media capturing element may be any means for capturing an image, video and/or audio for storage, display or transmission. For example, in an exemplary embodiment in which the media capturing element is a camera module 36, the camera module 36 may include a digital camera capable of forming a digital image file from a captured image. In addition, the digital camera of the camera module 36 may be capable of capturing a video clip. As such, the camera module 36 may include all hardware, such as a lens or other optical component(s), and software necessary for creating a digital image file from a captured image as well as a digital video file from a captured video clip. Alternatively, the camera module 36 may include only the hardware needed to view an image, while a memory device of the mobile terminal 10 stores instructions for execution by the processor 20 in the form of software necessary to create a digital image file from a captured image. As yet another alternative, an object or objects within a field of view of the camera module 36 may be displayed on the display 28 of the mobile terminal 10 to illustrate a view of an image currently displayed which may be captured if desired by the user. As such, as referred to hereinafter, an image may be either a captured image or an image comprising the object or objects currently displayed by the mobile terminal 10, but not necessarily captured in an image file. In an example embodiment, the camera module 36 may further include a processing element such as a co-processor which assists the processor 20 in processing image data and an encoder and/or decoder for compressing and/or decompressing image data. The encoder and/or decoder may encode and/or decode according to, for example, a joint photographic experts group (JPEG) standard, a moving picture experts group (MPEG) standard, or other format.

The mobile terminal 10 may further include a positioning sensor 37. The positioning sensor 37 may include, for example, a global positioning system (GPS) sensor, an assisted global positioning system (Assisted-GPS) sensor, etc. In one embodiment, however, the positioning sensor 37 includes a pedometer or inertial sensor. Further, the positioning sensor may determine the location of the mobile terminal 10 based upon signal triangulation or other mechanisms. The positioning sensor 37 may be configured to determine a location of the mobile terminal 10, such as latitude and longitude coordinates of the mobile terminal 10 or a position relative to a reference point such as a destination or a start point. Information from the positioning sensor 37 may be communicated to a memory of the mobile terminal 10 or to another memory device to be stored as a position history or location information. Furthermore, the memory of the mobile terminal 10 may store instructions for determining cell id information. In this regard, the memory may store an application program for execution by the processor 20, which may determine an identity of the current cell (e.g., cell id identity or cell id information) with which the mobile terminal 10 is in communication. In conjunction with the positioning sensor 37, the cell id information may be used to more accurately determine a location of the mobile terminal 10.

The mobile terminal 10 may comprise memory, such as a subscriber identity module (SIM) 38, a universal subscriber identity module (USIM), a removable user identity module (R-UIM), and/or the like, which may store information elements related to a mobile subscriber. In addition to the SIM, the mobile terminal may comprise other removable and/or fixed memory. The mobile terminal 10 may include volatile memory 40 and/or non-volatile memory 42. For example, volatile memory 40 may include Random Access Memory (RAM) including dynamic and/or static RAM, on-chip or off-chip cache memory, and/or the like. Non-volatile memory 42, which may be embedded and/or removable, may include, for example, read-only memory, flash memory, magnetic storage devices (for example, hard disks, floppy disk drives, magnetic tape, etc.), optical disc drives and/or media, non-volatile random access memory (NVRAM), and/or the like. Like volatile memory 40 non-volatile memory 42 may include a cache area for temporary storage of data. The memories may store one or more software programs, instructions, pieces of information, data, and/or the like which may be used by the mobile terminal for performing functions of the mobile terminal. For example, the memories may comprise an identifier, such as an international mobile equipment identification (IMEI) code, capable of uniquely identifying the mobile terminal 10.

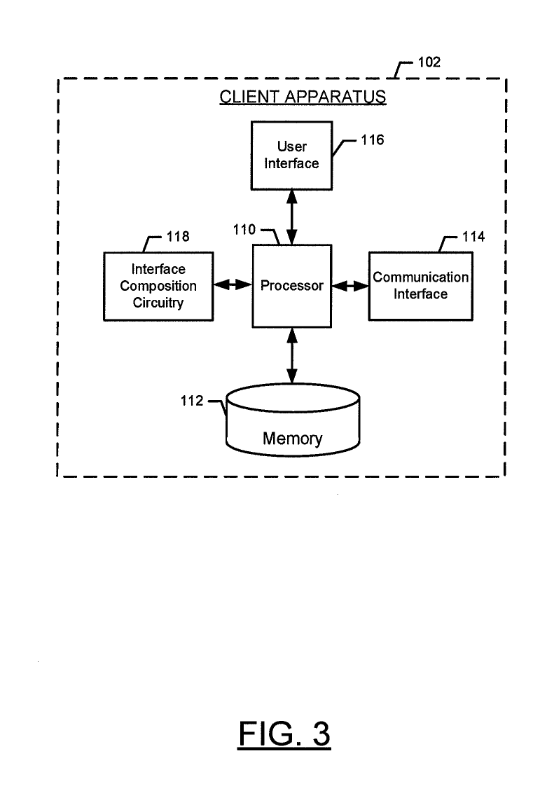

Referring now to FIG. 3, FIG. 3 illustrates a block diagram of a client apparatus 102 for generating an integrated user interface according to an example embodiment of the invention. The client apparatus 102 may include various means, such as one or more of a processor 110, memory 112, communication interface 114, user interface 116, or interface composition circuitry 118 for performing the various functions herein described. These means of the client apparatus 102 as described herein may be embodied as, for example, circuitry, hardware elements (for example, a suitably programmed processor, combinational logic circuit, and/or the like), a computer program product comprising computer-readable program instructions (for example, software or firmware) stored on a computer-readable medium (for example, memory 112) that is executable by a suitably configured processing device (for example, the processor 110), or some combination thereof.

The processor 110 may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. Accordingly, although illustrated in FIG. 3 as a single processor, in some embodiments the processor 110 comprises a plurality of processors. The plurality of processors may be in operative communication with each other and may be collectively configured to perform one or more functionalities of the client apparatus 102 as described herein. In embodiments wherein the client apparatus 102 is embodied as a mobile terminal 10, the processor 110 may be embodied as or comprise the processor 20. In some example embodiments, the processor 110 is configured to execute instructions stored in the memory 112 or otherwise accessible to the processor 110. These instructions, when executed by the processor 110, may cause the client apparatus 102 to perform one or more of the functionalities of the client apparatus 102 as described herein. As such, whether configured by hardware or software methods, or by a combination thereof, the processor 110 may comprise an entity capable of performing operations according to embodiments of the present invention while configured accordingly. Thus, for example, when the processor 110 is embodied as an ASIC, FPGA or the like, the processor 110 may comprise specifically configured hardware for conducting one or more operations described herein. Alternatively, as another example, when the processor 110 is embodied as an executor of instructions, such as may be stored in the memory 112, the instructions may specifically configure the processor 110 to perform one or more algorithms and operations described herein.

The memory 112 may comprise, for example, volatile memory, non-volatile memory, or some combination thereof. Although illustrated in FIG. 3 as a single memory, the memory 112 may comprise a plurality of memories. In various embodiments, the memory 112 may comprise, for example, a hard disk, random access memory, cache memory, flash memory, a compact disc read only memory (CD-ROM), digital versatile disc read only memory (DVD-ROM), an optical disc, circuitry configured to store information, or some combination thereof. In embodiments wherein the client apparatus 102 is embodied as a mobile terminal 10, the memory 112 may comprise the volatile memory 40 and/or the non-volatile memory 42. The memory 112 may be configured to store information, data, applications, instructions, or the like for enabling the client apparatus 102 to carry out various functions in accordance with example embodiments of the present invention. For example, in some example embodiments, the memory 112 is configured to buffer input data for processing by the processor 110. Additionally or alternatively, in some example embodiments, the memory 112 is configured to store program instructions for execution by the processor 110. The memory 112 may store information in the form of static and/or dynamic information. This stored information may be stored and/or used by the interface composition circuitry 118 during the course of performing its functionalities.

The communication interface 114 may be embodied as any device or means embodied in circuitry, hardware, a computer program product comprising computer readable program instructions stored on a computer readable medium (for example, the memory 112) and executed by a processing device (for example, the processor 110), or a combination thereof that is configured to receive and/or transmit data from/to an entity of the system 100, such as, for example, a server apparatus 104. In some example embodiments, the communication interface 114 is at least partially embodied as or otherwise controlled by the processor 110. The communication interface 114 may, for example, be in communication with the processor 110, such as via a bus. The communication interface 114 may include, for example, an antenna, a transmitter, a receiver, a transceiver and/or supporting hardware or software for enabling communications with one or more entities of the system 100. The communication interface 114 may be configured to receive and/or transmit data using any protocol that may be used for communications between entities of the system 100 over the network 106. The communication interface 114 may additionally be in communication with the memory 112, user interface 116, and/or interface composition circuitry 118, such as via a bus.

The user interface 116 may be in communication with the processor 110 to receive an indication of a user input and/or to provide an audible, visual, mechanical, haptic, and/or other output to a user. As such, the user interface 116 may include, for example, a keyboard, a mouse, a joystick, a display, a touch screen display, a microphone, a speaker, and/or other input/output mechanisms. The user interface 116 may be in communication with the memory 112, communication interface 114, and/or interface composition circuitry 118, such as via a bus.

The interface composition circuitry 118 may be embodied as various means, such as circuitry, hardware, a computer program product comprising computer readable program instructions stored on a computer readable medium (for example, the memory 112) and executed by a processing device (for example, the processor 110), or some combination thereof and, in some example embodiments, is embodied as or otherwise controlled by the processor 110. In embodiments wherein the interface composition circuitry 118 is embodied separately from the processor 110, the interface composition circuitry 118 may be in communication with the processor 110. The interface composition circuitry 118 may further be in communication with one or more of the memory 112, communication interface 114, or user interface 116, such as via a bus.

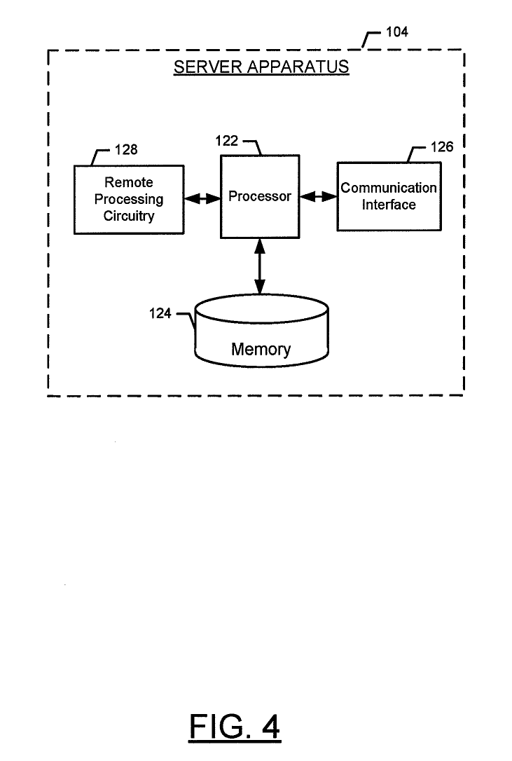

FIG. 4 illustrates a block diagram of a server apparatus 104 for facilitating generation of an integrated user interface according to an example embodiment of the invention. The server apparatus 104 may include various means, such as one or more of a processor 122, memory 124, communication interface 126, or remote processing circuitry 128 for performing the various functions herein described. These means of the server apparatus 104 as described herein may be embodied as, for example, circuitry, hardware elements (for example, a suitably programmed processor, combinational logic circuit, and/or the like), a computer program product comprising computer-readable program instructions (for example, software or firmware) stored on a computer-readable medium (for example, memory 124) that is executable by a suitably configured processing device (for example, the processor 122), or some combination thereof.

The processor 122 may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. Accordingly, although illustrated in FIG. 4 as a single processor, in some embodiments the processor 122 comprises a plurality of processors. The plurality of processors may be in operative communication with each other and may be collectively configured to perform one or more functionalities of the server apparatus 104 as described herein. The plurality of processors may be embodied on a single computing device or may be distributed across a plurality of computing devices collectively configured to perform one or more functionalities of the server apparatus 104 as described herein. In some example embodiments, the processor 122 is configured to execute instructions stored in the memory 124 or otherwise accessible to the processor 122. These instructions, when executed by the processor 122, may cause the server apparatus 104 to perform one or more of the functionalities of the server apparatus 104 as described herein. As such, whether configured by hardware or software methods, or by a combination thereof, the processor 122 may comprise an entity capable of performing operations according to embodiments of the present invention while configured accordingly. Thus, for example, when the processor 122 is embodied as an ASIC, FPGA or the like, the processor 122 may comprise specifically configured hardware for conducting one or more operations described herein. Alternatively, as another example, when the processor 122 is embodied as an executor of instructions, such as may be stored in the memory 124, the instructions may specifically configure the processor 122 to perform one or more algorithms and operations described herein.

The memory 124 may comprise, for example, volatile memory, non-volatile memory, or some combination thereof. Although illustrated in FIG. 4 as a single memory, the memory 124 may comprise a plurality of memories. The plurality of memories may be embodied on a single computing device or distributed across a plurality of computing devices that may collectively comprise the server apparatus 104. In various embodiments, the memory 124 may comprise, for example, a hard disk, random access memory, cache memory, flash memory, a compact disc read only memory (CD-ROM), digital versatile disc read only memory (DVD-ROM), an optical disc, circuitry configured to store information, or some combination thereof. The memory 124 may be configured to store information, data, applications, instructions, or the like for enabling the server apparatus 104 to carry out various functions in accordance with various example embodiments. For example, in some example embodiments, the memory 124 is configured to buffer input data for processing by the processor 122. Additionally or alternatively, in some example embodiments, the memory 124 is configured to store program instructions for execution by the processor 122. The memory 124 may store information in the form of static and/or dynamic information. This stored information may be stored and/or used by remote processing circuitry 128 during the course of performing its functionalities.

The communication interface 126 may be embodied as any device or means embodied in circuitry, hardware, a computer program product comprising computer readable program instructions stored on a computer readable medium (for example, the memory 124) and executed by a processing device (for example, the processor 122), or a combination thereof that is configured to receive and/or transmit data from/to an entity of the system 100, such as, for example, a client apparatus 102. In some example embodiments, the communication interface 126 is at least partially embodied as or otherwise controlled by the processor 122. In this regard, the communication interface 126 may be in communication with the processor 122, such as via a bus. The communication interface 126 may include, for example, an antenna, a transmitter, a receiver, a transceiver and/or supporting hardware or software for enabling communications with one or more entities of the system 100. The communication interface 126 may be configured to receive and/or transmit data using any protocol that may be used for communications between entities of the system 100 over the network 106. The communication interface 126 may additionally be in communication with the memory 124 and/or remote processing circuitry 128, such as via a bus.

The remote processing circuitry 128 may be embodied as various means, such as circuitry, hardware, a computer program product comprising computer readable program instructions stored on a computer readable medium (for example, the memory 124) and executed by a processing device (for example, the processor 122), or some combination thereof and, in some example embodiments, is embodied as or otherwise controlled by the processor 122. In embodiments wherein the remote processing circuitry 128 is embodied separately from the processor 122, the remote processing circuitry 128 may be in communication with the processor 122. The remote processing circuitry 128 may further be in communication with the memory 124 and/or communication interface 126, such as via a bus.

In some example embodiments, one or more applications referred to as “client applications” reside on the client apparatus 102. A client application may comprise code stored on the memory 112 and may, for example, be executed by and/or under the control of one or more of the processor 110 or interface composition circuitry 118. A client application may be configured to generate user interface information. The user interface information may comprise, for example, visual information for display on a display of the user interface 116, audio information for output by a speaker or other audio output device of the user interface 116, haptic feedback information for providing tactile feedback via an appropriate mechanism of the user interface 116, some combination thereof, or the like.

Similarly, in some example embodiments, one or more applications referred to as “server applications” reside on the server apparatus 104. A server application may comprise code stored on the memory 124 and may, for example, be executed by and/or under the control of one or more of the processor 122 or remote processing circuitry 128. A server application may be configured to generate user interface information. The user interface information may comprise, for example, visual information for display on a display, audio information for output by a speaker or other audio output device, haptic feedback information, some combination thereof, or the like. A server application may be configured to generate user interface information based at least in part on data provided to the server apparatus 104 by the client apparatus 102, as will be described further herein below. The remote processing circuitry 128 may be configured to cause user interface information generated by a server application to be sent to the client apparatus 102.

In some example embodiments, the interface composition circuitry 118 is configured to obtain first user interface information generated by a client application. In this regard, the interface composition circuitry 118 may, for example, be configured to receive, request, and/or otherwise access the first user interface information by way of an application programming interface (API) between the client application and the interface composition circuitry 118. As another example, user interface information generated by the client application may be buffered and/or otherwise stored in a memory, such as the memory 112 and the interface composition circuitry 118 may be configured to access the first user interface information from a memory on which it is stored. As a further example, in some example embodiments wherein the interface composition circuitry 118 is configured to execute, control, or is otherwise in direct communication with the client application, the interface composition circuitry 118 may be configured to obtain the first user interface information as it is generated by the client application.

The interface composition circuitry 118 may be further configured to obtain second user interface information generated by a server application. The second user interface information may have been sent to the client apparatus 102 by the server apparatus 104. In this regard, the interface composition circuitry 118 may, for example, be configured to receive the second user interface information, such as, for example, via the communication interface 114. As another example, the interface composition circuitry 118 may be configured to obtain the second user interface information by accessing the second user interface information from a memory (e.g., the memory 112) where it may be buffered or otherwise stored as it is received by the client apparatus 102.

The interface composition circuitry 118 may be additionally configured to combine the first and second user interface information to generate an integrated application user interface. The interface composition circuitry 118 may be configured to cause the resulting integrated application user interface to be output by the user interface 116 so that a user of the client apparatus 102 may view, hear, and/or otherwise interact with the integrated application user interface via the user interface 116. In this regard, the integrated application user interface generated by the interface composition circuitry 118 may comprise aspects (e.g., visual aspects, audio aspects, haptic feedback aspects, and/or the like) of both the first and second user interface information that are integrated in such a way to provide a seamless application user interface to a user.

The first and second user interface information may comprise respective user interface layers. For example, the first user interface information generated by the client application may comprise a base user interface layer and the second user interface information generated by the server application may comprise an overlay user interface layer. The interface composition circuitry 118 may accordingly be configured to combine the first and second user interface information by overlaying the overlay user interface layer over the base user interface layer. In this regard, the interface composition circuitry 118 may be configured to overlay the visual aspects of the overlay layer over the visual aspects of the base layer, the audio aspects of the overlay layer over the audio aspects of the base layer, and/or the like.

It will be appreciated, however, that in embodiments wherein the first and second user interface information comprise user interface layers, the first and second user interface are not limited to respectively comprising a base user interface layer and an overlay user interface layer. In this regard, for example, the first user interface information generated by the client application may comprise an overlay user interface layer and the second user interface information generated by the server application may comprise a base user interface layer. Accordingly, the interface composition circuitry 118 may additionally or alternatively be configured to combine the first and second user interface information by overlaying an overlay user interface layer generated by the client application over a base user interface layer generated by the server application.

Further, it will be appreciated that the interface composition circuitry 118 may be configured in some example embodiments to combine the first and second user interface information with additional user interface information. The additional user interface information may, for example, be obtained from a local source (e.g., a client application, though not necessarily the same client application as generated the first user interface information) and/or may be provided to the client apparatus 102 by another apparatus in communication with the client apparatus 102. Additionally or alternatively, the interface composition circuitry 118 may be configured to generate additional user interface information to combine with the first and second user interface information. This additional user interface information may, for example, be generated by the interface composition circuitry 118 based at least in part on content of one or more of the first or second user interface information.

In embodiments wherein the second user interface information is generated by the server application based at least in part on data provided to the server apparatus 104 by the client apparatus 102, the interface composition circuitry 118 or other element of the client apparatus 102 may be configured to provide the data to the server apparatus 104 in parallel with generation of the first user interface information by the client application. In this regard, the remote processing circuitry 128 may receive the data provided by the client apparatus 102 and process the data to derive information from the data that may form the basis for the second user interface information. Accordingly, processing burdens may be offloaded from the client apparatus 102 to the server apparatus 104. In this regard, the client application and server application may serve as distributed pipelined applications and may generate the first and second user interface information in parallel. However, it will be appreciated that the client and server applications may not be aware of each other's presence and in some embodiments are not specifically configured to interact with each other. In this regard, the interface composition circuitry 118 and/or remote processing circuitry 128 may be configured to serve as an intermediate interface such that the client and server applications may be invisible to each other. Such embodiments may allow remote processing functionality of a server application to be harnessed to provide a value added service that may enhance user experience even when using legacy client applications.

The data provided by the client apparatus 102 may, for example, comprise a representation of the first user interface information. As another example, the data provided by the client apparatus 102 may comprise sensory data captured by the client apparatus 102 (e.g., by a camera, microphone, and/or the like of the client apparatus 102) that may provide a sense of an environment (e.g., context) of the client apparatus 102, video data, audio data, image data, an indication of a user interaction with the user interface 116, some combination thereof, or the like. The remote processing circuitry 128 may be configured to derive information by processing the data received by the client apparatus 102.

As another example, where the data provided by the client apparatus 102 comprises context or sense of environment information (e.g., image data and/or audio data captured by the client apparatus 102), the remote processing circuitry 128 may be configured to process the data to determine additional information about the environment and/or context of the client apparatus 102, such as through object recognition analysis of the data. In this regard, the remote processing circuitry 128 may, for example, be configured to identify faces, objects, landmarks, and/or the like illustrated in image data. Additionally or alternatively, the remote processing circuitry 128 may be configured to identify sounds and/or sound producing objects (e.g., animals, machines, individuals identified through voice recognition, and/or the like) through analysis of audio data. The results of the object recognition analysis may be provided to the client apparatus 102 by way of the second user interface information. In this regard, the result(s) of the object recognition analysis may, for example, be indicated by way of a user interface overlay that the interface composition circuitry 118 may combine with a user interface layer generated by the client application. The user interface layer generated by the client application may, for example, contain a representation of the data processed by the remote processing circuitry 128 such that the overlay indicating the result(s) of the object recognition analysis may be overlaid over a representation(s) of the respective object(s).

The interface composition circuitry 118 may be further configured to preprocess captured or other data to generate a reduced size representation of the data. It may be the reduced size representation of the data that is provided to the server apparatus 104 for processing. In this regard, transfer of reduced size data may conserve network bandwidth, reduce power consumption by the client apparatus 102, and/or the like, while still providing the server apparatus 104 with data having enough detail to enable the server application to generate the second user interface information. The interface composition circuitry 118 may be configured to preprocess data using any appropriate scheme or algorithm suitable for reducing the size of the data. As an example, the interface composition circuitry 118 may be configured to preprocess image data having a first resolution to generate reduced image data having a reduced resolution that is smaller than the first resolution. As another example, the interface composition circuitry 118 may be configured to preprocess video data having a first frame rate to generate reduced video data having a reduced frame rate. The interface composition circuitry 118 may additionally or alternatively be configured to preprocess data by applying a compression scheme to the data so as to reduce the data size. It will be appreciated, however, that the above example methods of reducing data size are provided merely by way of example and not by way of limitation. Accordingly, the interface composition circuitry 118 may be configured to preprocess data so as to reduce data size in accordance with any appropriate data size reduction method or combination of data size reduction methods.

In some embodiments wherein the interface composition circuitry 118 is configured to preprocess data prior to sending it to the server apparatus 604, the interface composition circuitry 118 and remote processing circuitry 128 may be configured to collaboratively negotiate a data reduction scheme. In this regard, the interface composition circuitry 118 and remote processing circuitry 128 may be configured to exchange signaling to negotiate a method by which to reduce data size. This negotiation may, for example, be based on data type, network conditions, capabilities of the client apparatus 102 and server apparatus 104, some combination thereof, or the like. In some example embodiments, the interface composition circuitry 118 may be configured to preprocess data in accordance with any one or more of the techniques for preprocessing data to generate reduced data for remote processing described in U.S. patent application Ser. No. 12/768,288, filed on Apr. 27, 2010, the contents of which are incorporated herein by reference.

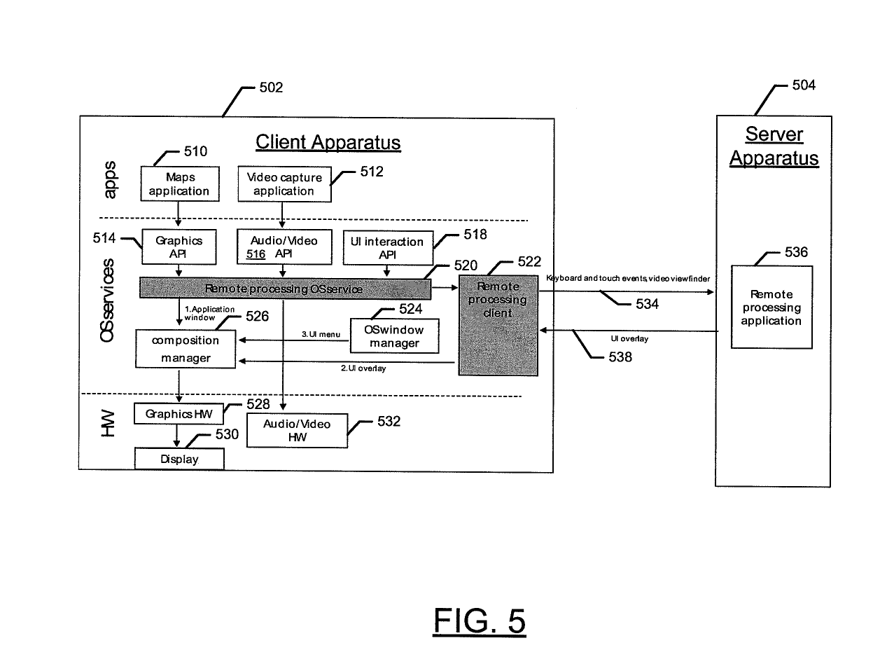

Referring now to FIG. 5, FIG. 5 illustrates an example architecture for generating an integrated user interface according to an example embodiment. In this regard, FIG. 5 illustrates an example architecture wherein the client application is not aware of the server application such that the server and client applications are completely independent. As illustrated in FIG. 5, the example architecture comprises a client apparatus 502, which may comprise an embodiment of the client apparatus 102, and a server apparatus 504, which may comprise an embodiment of the server apparatus 104. Accordingly, one or more of the architecture elements illustrated and described with respect to the client apparatus 502 may be implemented by, executed by, controlled by, and/or in communication with one or more of the processor 110, memory 112, communication interface 114, user interface 116, or interface composition circuitry 118. Similarly, one or more of the architecture elements illustrated and described with respect to the server apparatus 504 may be implemented by, executed by, controlled by, and/or in communication with one or more of the processor 122, memory 124, communication interface 126, or remote processing circuitry 128.

One or more client applications may reside on the client apparatus 502. For purposes of example, a maps application 510 and video capture application 512 are illustrated. The interface composition circuitry 118 may be configured to control and/or interface with a plurality of operating system services to enable generation of an integrated application user interface. In operation, the client application(s) may provide user interface information and/or other data to a one or more APIs. The APIs may include, for example, a graphics API 514, audio/video API 516, user interface (UI) interaction API 518, and/or the like. A remote processing operating system (OS) service 520 may be configured to obtain user interface information and/or other data generated by the client application(s) from the API(s). At least a portion of this information or a reduced size representation thereof may be provided to the server apparatus 504 by way of a remote processing client 522. In this regard, the remote processing OS service 520 and/or remote processing client 522 may be configured to provide a connection to server applications functionality. This functionality, may, for example, be accessible from an operating system user interface menu provided by an operating system residing on the client apparatus 502.

The remote processing client 522 may be configured to include connection information in a connection request sent to the server apparatus 504. This connection information may, for example, include a name of a client application, a version of the client application, a directory (or path definition) on which the client application resides, a user identification of a user of the client apparatus 502, configuration information for the client apparatus 502, and/or the like. In this regard, the connection information may enable the remote processing application 536 to appropriately configure and initialize the server application.

As illustrated by reference 534, the remote processing client 522 may be configured to send data, such as keyboard and touch event data, video viewfinder data captured by the video capture application 512, and/or the like to the server apparatus 504. It will be appreciated that video viewfinder data is illustrated in and discussed with respect to FIG. 5 by way of example in correspondence to the video capture application 512 and not by way of limitation. Accordingly, other types of captured and/or generated data may be provided to the server apparatus 504 by the client apparatus 502 for processing. The remote processing application 536 may process the received data and generate a user interface overlay. As illustrated by reference 538, the generated user interface overlay may be sent to the client apparatus 502. The composition manager 526, which may, for example, be implemented by or operate under the control of the interface composition circuitry 118, may obtain an application window and/or other user interface information generated by the client application(s) as well as the user interface overlay generated by the remote processing application 536. The composition manager 526 may combine the user interface information generated by the client application(s) and the user interface overlay to generate an integrated visual application user interface. The integrated visual application user interface may be provided to the graphics hardware 528, which may display the integrated visual application user interface on the display 530. It will be appreciated that the composition manager 526 may be configured to combine user interface aspects in addition to or in alternative to visual user interface aspects. Accordingly, other aspects of an integrated application user interface generated by the composition manager 526 may be provided to appropriate user interface control elements for output to a user. Thus, for example, audio user interface data combined or otherwise generated by the composition manager 526 may, for example, be provided to the audio/video hardware 532 for output to a user of the client apparatus 502.

In addition to the user interface information, the composition manager 526 may also be configured to combine a user interface menu or other operating system level interface features into the integrated application user interface. Such operating system level interface features may be provided to the composition manager 526 by the OS window manager 524 in parallel with the user interface overlay and user interface information generated by the client application(s).

While the full implementation architecture for the server apparatus 504 is not illustrated in FIG. 5, the implementation structure may mimic that illustrated with respect to the client apparatus 502. In this regard, the server apparatus 504 may, for example, include a remote processing server service and remote processing server configured to facilitate pairing the client and server applications. Such an implementation may allow for use of legacy server applications. In this regard, in embodiments wherein the client and server applications are not necessarily aware of each other, a legacy client and server application may be paired in a manner that is transparent to the client and server application such that features provided by the client and server application may be combined into an integrated value added application user interface. One can see this architecture as a source-sink type of processing where remote processing capabilities—Remote processing OS service 520, Remote processing client 522, remote processing server (server side, not illustrated), remote processing server service (server side, not illustrated), and/or the like—capture the data flow at some points and bypass the data to appropriate sources and sinks.

In an instance in which a legacy application is configured to cooperate with a remote application in a parallel distributed manner as described herein, the server application may be viewed as an extension to the legacy client application. In this regard, in some example embodiments, the remote processing application 536 may be viewed as a monolithic implementation containing functionalities of the remote processing server service, remote processing server, and server application.

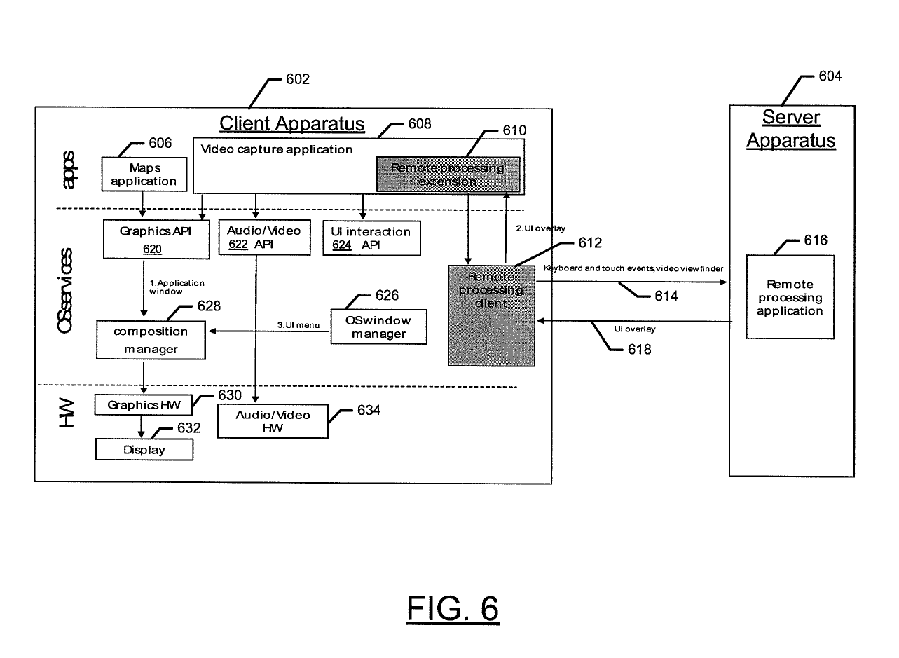

Referring now to FIG. 6, FIG. 6 illustrates an example architecture for generating an integrated user interface according to another example embodiment. In this regard, FIG. 6 illustrates an example architecture wherein the client application and server application are aware of each other. In such an embodiment, the client application may have been developed or otherwise tailored to assume that a counterpart server application exists. Similarly, the server application may have been developed or otherwise tailored to assume that a counterpart client application exists. The degree to which a client application and server application are coupled in such embodiments may vary.

As illustrated in FIG. 6, the example architecture comprises a client apparatus 602, which may comprise an embodiment of the client apparatus 102, and a server apparatus 604, which may comprise an embodiment of the server apparatus 104. Accordingly, one or more of the architecture elements illustrated and described with respect to the client apparatus 602 may be implemented by, executed by, controlled by, and/or in communication with one or more of the processor 110, memory 112, communication interface 114, user interface 116, or interface composition circuitry 118. Similarly, one or more of the architecture elements illustrated and described with respect to the server apparatus 604 may be implemented by, executed by, controlled by, and/or in communication with one or more of the processor 122, memory 124, communication interface 126, or remote processing circuitry 128.

One or more client applications may reside on the client apparatus 602. For purposes of example, a maps application 606 and video capture application 608 are illustrated. The interface composition circuitry 118 may be configured to control and/or interface with a plurality of operating system services to enable generation of an integrated application user interface. In operation, the client application(s) may provide user interface information and/or other data to one or more APIs. The APIs may include, for example, a graphics API 620, audio/video API 622, user interface (UI) interaction API 624, and/or the like. A composition manager 628 may be configured to obtain user interface information and/or other data generated by the client application(s) from the API(s).

In contrast to the architecture illustrated in FIG. 5, in the architecture illustrated in FIG. 6, a client application may comprise an integrated or embedded remote processing extension, as the client application may be aware of the remote server application and configured to facilitate distributed parallel processing to enable the generation of an integrated application user interface from user interface information provided by both the client application and the server application. In FIG. 6, a remote processing extension 610 is illustrated as being integrated with the video capture application 608. Accordingly, in such embodiments, the remote processing service extension may not be provided as an operating system service. In embodiments such as that illustrated in FIG. 6, usage of the remote processing application 616 or other server application may mimic usage of a thin client. However, unlike with a thin client, the client and server application may each contribute user interface information (e.g., user interface layers) that may be combined by interface composition circuitry 118 to generate an integrated application user interface. After launching the remote processing application 616, the flow of interactions between the video capture application 608 (or other client application) and remote processing application 616 (or other server application) may be at least substantially continuous. However, it will be appreciated that in the example architecture illustrated in FIG. 6, the application logic is local on both sides such that the client application logic resides on the client apparatus 602 and the server application logic resides on the server apparatus 604.

A remote processing client 612 may be configured to interface with the remote processing extension 610 to obtain data generated by the video capture application 608 (and/or other client application). The remote processing client 612 may be configured to send the obtained data or a reduced representation thereof to the server apparatus 604. As illustrated by reference 614, the remote processing client 612 may be configured to send data, such as keyboard and touch event data, video viewfinder data captured by the video capture application 608, and/or the like to the server apparatus 604. It will be appreciated that video viewfinder data is illustrated in and discussed with respect to FIG. 6 by way of example in correspondence to the video capture application 612 and not by way of limitation. Accordingly, other types of captured and/or generated data may be provided to the server apparatus 604 by the client apparatus 602 for processing. The remote processing application 616 may process the received data and generate a user interface overlay. As illustrated by reference 618, the generated user interface overlay may be sent to the client apparatus 602.

The composition manager 628, which may, for example, be implemented by or operate under the control of the interface composition circuitry 118, may obtain an application window and/or other user interface information generated by the client application(s) as well as the user interface overlay generated by the remote processing application 616. The composition manager 628 may combine the user interface information generated by the client application(s) and the user interface overlay to generate an integrated visual application user interface. The integrated visual application user interface may be provided to the graphics hardware 630, which may display the integrated visual application user interface on the display 632. It will be appreciated that the composition manager 628 may be configured to combine user interface aspects in addition to or in alternative to visual user interface aspects. Accordingly, other aspects of an integrated application user interface generated by the composition manager 628 may be provided to appropriate user interface control elements for output to a user. Thus, for example, audio user interface data combined or otherwise generated by the composition manager 628 may, for example, be provided to the audio/video hardware 634 for output to a user of the client apparatus 602.

In addition to the user interface information, the composition manager 628 may also be configured to combine a user interface menu or other operating system level interface features into the integrated application user interface. Such operating system level interface features may be provided to the composition manager 628 by the Operating System (OS) window manager 626 in parallel with the user interface overlay and user interface information generated by the client application(s).

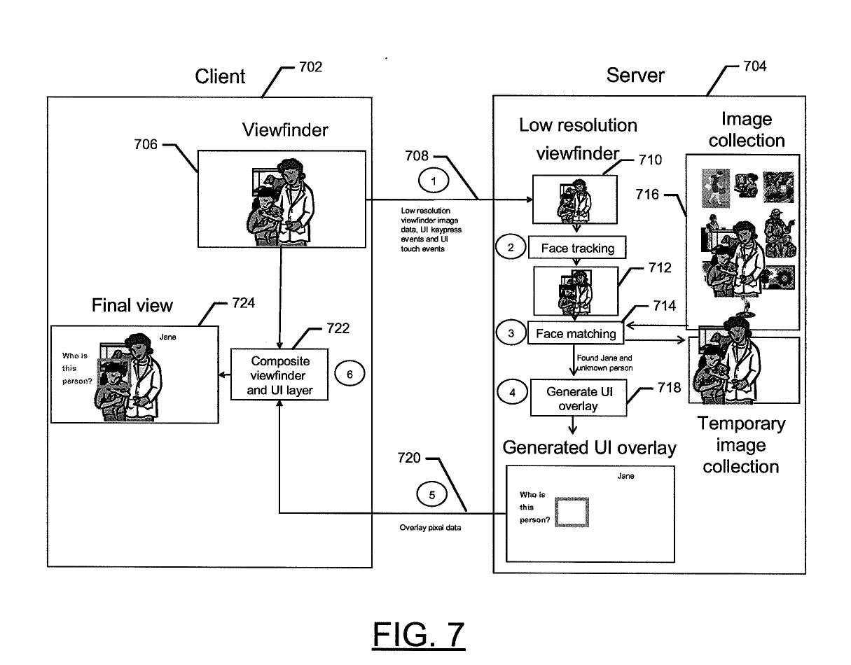

Referring now to FIG. 7, FIG. 7 illustrates generation of an object recognition user interface according to an example embodiment. A client apparatus 702 and server apparatus 704 are illustrated in FIG. 7. The client apparatus 702 may, for example, comprise an embodiment of the client apparatus 102. The server apparatus 704 may, for example, comprise an embodiment of the server apparatus 104. A viewfinder client application may reside on the client apparatus 702 and may be configured to obtain an image and/or video captured by a camera or other image capture device embodied on or otherwise operably coupled to the client apparatus 702. In this regard, the viewfinder client application may take camera sensor data as an input and return an image or video stream as an output.

As illustrated in reference 706, the viewfinder client application may have a captured image. The interface composition circuitry 118 may preprocess the captured image to generate a reduced size lower resolution representation of the captured image. The interface composition circuitry 118 may cause the reduced size representation of the captured image to be sent to the server apparatus 704, as illustrated by reference 708. In addition to the reduced size representation of the captured image, the interface composition circuitry 118 may cause indications of user interface inputs (e.g., key press events, interactions with a touch screen display, and/or the like) and/or other data to the server apparatus 704 to enable processing of the reduced size representation of the captured image and generation of a user interface overlay.

A face and/or general object recognition application (“face recognition application”) may reside on the server apparatus 704. Operation of the face recognition application may, for example, be controlled by the remote processing circuitry 128. Alternatively, the face recognition application may be in communication with the remote processing circuitry 128 such that the remote processing circuitry 128 may receive data output of the face recognition application. As illustrated in reference 710, the face recognition application may receive the reduced size representation of the captured image and may perform face tracking to identify faces in the image. Reference 712 illustrates identification of the faces in the image. At reference 714, the face recognition application may perform face matching to identify the persons in the image. In this regard, the face recognition application may consult an image collection stored in the memory 124 to identify the tracked faces. The face recognition application may perform facial recognition using any appropriate face recognition algorithm.

As illustrated in FIG. 7, the face recognition application may identify one of the persons illustrated in the image as “Jane” and may not be able to identify the second person. At reference 718, the remote processing circuitry 128 may generate a user interface overlay indicating the results of the face recognition processing on the image. The user interface overlay may be sent to the client apparatus 702, as illustrated by reference 720. The interface composition circuitry 118 may obtain the generated user interface overlay and combine the user interface overlay with user interface information comprising the original captured image provided by the viewfinder application. As illustrated by reference 724, the resulting integrated application user interface may comprise identification labels identifying the persons illustrated in the image. Accordingly, a user may be provided with an integrated face recognition/identification user interface that appears to the user as a single application while some processing tasks and storage requirements for storing an image collection for object matching may be offloaded to the server apparatus 704. While face recognition and identification of persons has been discussed with respect to FIG. 7, it will be appreciated that some example embodiments may be configured to similarly provide for generation of an integrated application user interface identifying other objects, such as buildings, landmarks, terrain features, animals, sources of sounds, and/or the like.

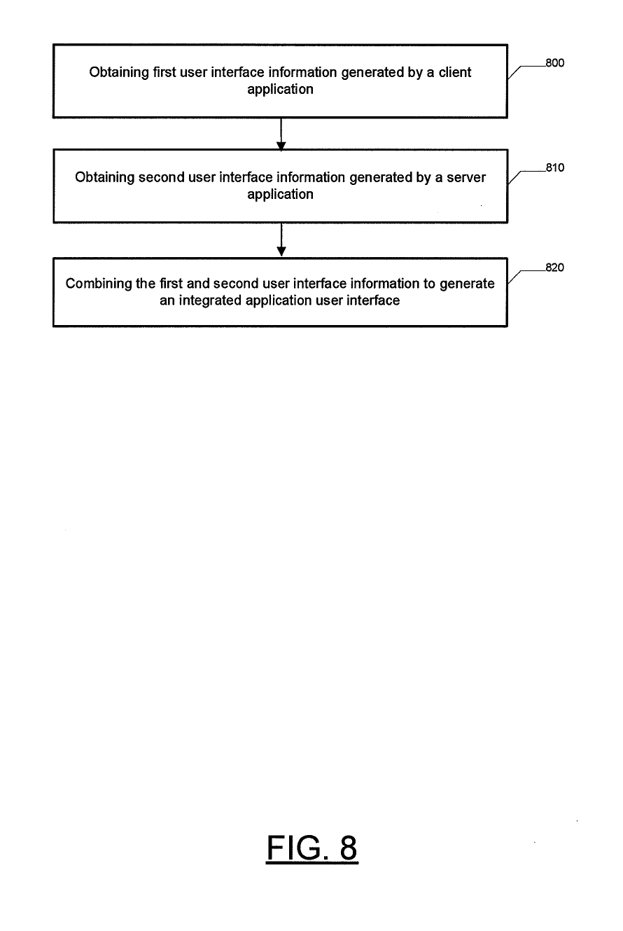

FIG. 8 illustrates a flowchart according to an example method for generating an integrated application user interface according to an example embodiment of the invention. In this regard, FIG. 8 illustrates operations that may, for example, be performed at the client apparatus 102. The operations illustrated in and described with respect to FIG. 8 may, for example, be performed by and/or under control of one or more of the processor 110, memory 112, communication interface 114, user interface 116, or interface composition circuitry 118. Operation 800 may comprise obtaining first user interface information generated by a client application. Operation 810 may comprise obtaining second user interface information generated by a server application. Operation 820 may comprise combining the first and second user interface information to generate an integrated application user interface. The first and second user interface information may, for example, comprise user interface layers and operation 820 may comprise overlaying one of the layers on top of the other layer.

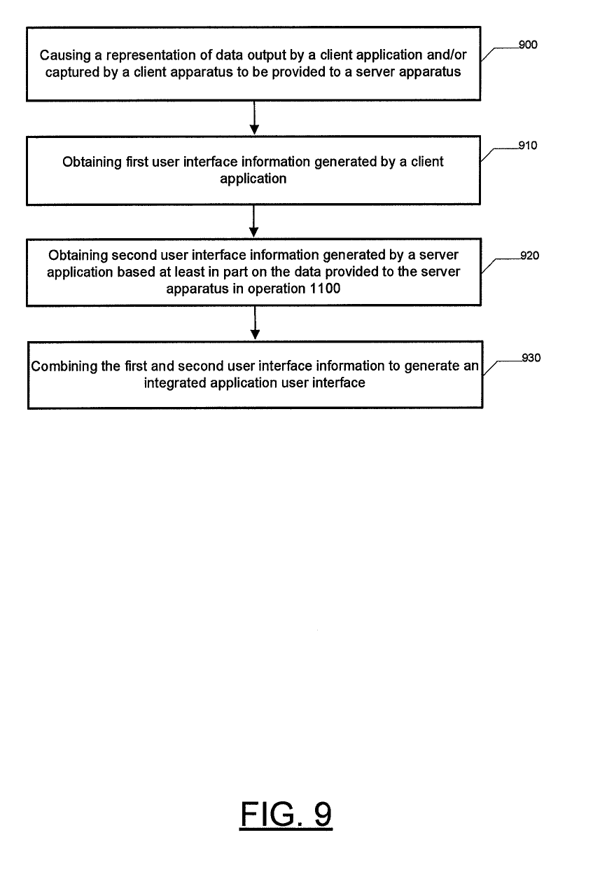

FIG. 9 illustrates a flowchart according to an example method for generating an integrated application user interface according to an example embodiment of the invention. In this regard, FIG. 9 illustrates operations that may, for example, be performed at the client apparatus 102. The operations illustrated in and described with respect to FIG. 9 may, for example, be performed by and/or under control of one or more of the processor 110, memory 112, communication interface 114, user interface 116, or interface composition circuitry 118. Operation 900 may comprise causing a representation of data output by a client application and/or captured by a client apparatus to be provided to a server apparatus. Operation 910 may comprise obtaining first user interface information generated by a client application. Operation 920 may comprise obtaining second user interface information generated by a server application based at least in part on the data provided to the server apparatus in operation 900. Operation 930 may comprise combining the first and second user interface information to generate an integrated application user interface. The first and second user interface information may, for example, comprise user interface layers and operation 930 may comprise overlaying one of the layers on top of the other layer.

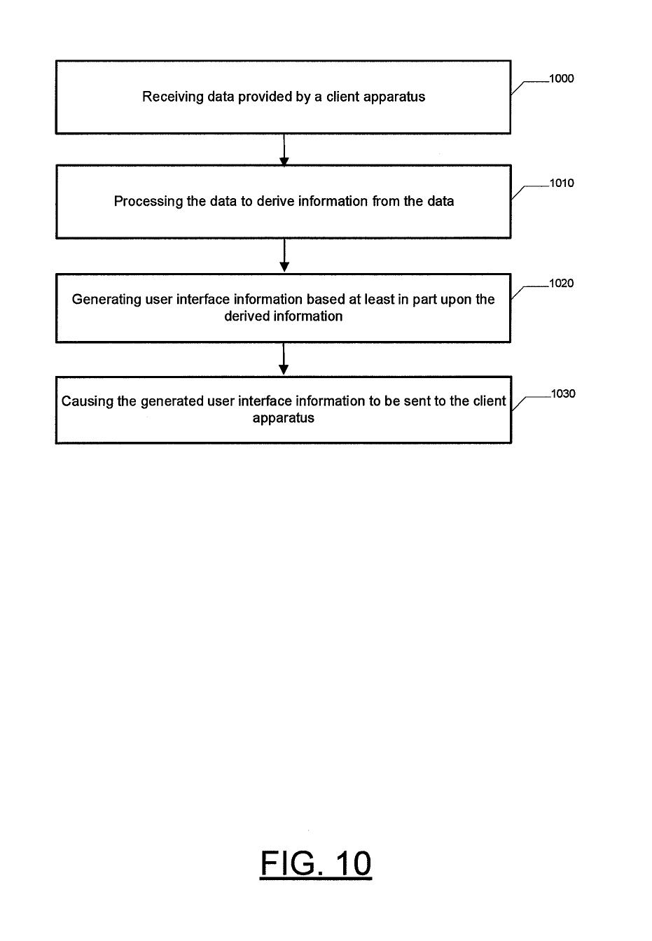

FIG. 10 illustrates a flowchart according to an example method for facilitating generation of an integrated application user interface according to an example embodiment of the invention. In this regard, FIG. 10 illustrates operations that may, for example, be performed at the server apparatus 104. The operations illustrated in and described with respect to FIG. 10 may, for example, be performed by and/or under control of one or more of the processor 122, memory 124, communication interface 126, or remote processing circuitry 128. Operation 1000 may comprise receiving data provided by a client apparatus. Operation 1010 may comprise processing the data to derive information from the data. Operation 1020 may comprise generating user interface information based at least in part upon the derived information. The user interface information may, for example, comprise a user interface overlay. Operation 1030 may comprise causing the generated user interface information to be sent to the client apparatus.

FIGS. 8-10 are flowcharts of a system, method, and computer program product according to example embodiments of the invention. It will be understood that each block of the flowcharts, and combinations of blocks in the flowcharts, may be implemented by various means, such as hardware and/or a computer program product comprising one or more computer-readable mediums having computer readable program instructions stored thereon. For example, one or more of the procedures described herein may be embodied by computer program instructions of a computer program product. In this regard, the computer program product(s) which embody the procedures described herein may be stored by one or more memory devices of a mobile terminal, server, or other computing device and executed by a processor in the computing device. In some embodiments, the computer program instructions comprising the computer program product(s) which embody the procedures described above may be stored by memory devices of a plurality of computing devices. As will be appreciated, any such computer program product may be loaded onto a computer or other programmable apparatus to produce a machine, such that the computer program product including the instructions which execute on the computer or other programmable apparatus creates means for implementing the functions specified in the flowchart block(s). Further, the computer program product may comprise one or more computer-readable memories (e.g., memory 112 and/or memory 124) on which the computer program instructions may be stored such that the one or more computer-readable memories can direct a computer or other programmable apparatus to function in a particular manner, such that the computer program product comprises an article of manufacture which implements the function specified in the flowchart block(s). The computer program instructions of one or more computer program products may also be loaded onto a computer or other programmable apparatus (for example, client apparatus 102 and/or server apparatus 104) to cause a series of operations to be performed on the computer or other programmable apparatus to produce a computer-implemented process such that the instructions which execute on the computer or other programmable apparatus implement the functions specified in the flowchart block(s).

Accordingly, blocks of the flowcharts support combinations of means for performing the specified functions. It will also be understood that one or more blocks of the flowcharts, and combinations of blocks in the flowcharts, may be implemented by special purpose hardware-based computer systems which perform the specified functions, or combinations of special purpose hardware and computer program product(s).

The above described functions may be carried out in many ways. For example, any suitable means for carrying out each of the functions described above may be employed to carry out embodiments of the invention. In one embodiment, a suitably configured processor (e.g., the processor 110 and/or processor 122) may provide all or a portion of the elements. In another embodiment, all or a portion of the elements may be configured by and operate under control of a computer program product. The computer program product for performing the methods of embodiments of the invention includes a computer-readable storage medium, such as a non-volatile storage medium or other non-transitory or tangible storage medium, and computer-readable program code portions, such as a series of computer instructions, embodied in the computer-readable storage medium.

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the invention. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the invention. In this regard, for example, different combinations of elements and/or functions than those explicitly described above are also contemplated within the scope of the invention. Although specific terms are employed herein, they are used in a generic and descriptive sense only and not for purposes of limitation.

What is claimed is:

1. A method comprising:
obtaining, in a client apparatus, first user interface information generated by a client application residing on the client apparatus;
obtaining, in the client apparatus, second user interface information generated by a server application residing on a remote server apparatus; and
combining, by interface composition circuitry, the first and second user interface information to generate an integrated application user interface.

2. The method of claim 1, wherein the first user interface information comprises a base user interface layer and the second user interface information comprises an overlay user interface layer, and wherein combining the first and second user interface information comprises overlaying the overlay user interface layer on the base user interface layer.

3. The method of claim 1, wherein the second user interface information is generated by the server application based at least in part on data provided to the server apparatus by the client apparatus.

4. The method of claim 3, wherein the data provided to the server apparatus comprises one or more of sensory data captured by the client apparatus, video data, audio data, image data, or an indication of a user interaction with a user interface of the client apparatus.

5. The method of claim 3, wherein the data provided to the server apparatus comprises preprocessed data generated by preprocessing original data, the preprocessed data comprising a reduced size representation of the original data.

6. The method of claim 1, wherein the first and second user interface information comprise one or more of visual information, audio information, or haptic feedback information.

7. The method of claim 1, further comprising causing the integrated application user interface to be output by a user interface of the client apparatus.

8. The method of claim 1, wherein the first user interface information comprises image data and the second user interface information comprises identification information identifying content of the image data, the method further comprising:
causing a representation of the image data to be provided to the server apparatus to enable the server application to derive the identification information; and
wherein combining the first and second user information comprises overlaying the identification information on the image data.

9. An apparatus comprising at least one processor and at least one memory storing computer program code, wherein the at least one memory and stored computer program code are configured, with the at least one processor, to cause the apparatus to at least:
obtain first user interface information generated by a client application residing on the apparatus;
obtain second user interface information generated by a server application residing on a remote server apparatus; and
combine the first and second user interface information to generate an integrated application user interface.

10. The apparatus of claim 9, wherein the first user interface information comprises a base user interface layer and the second user interface information comprises an overlay user interface layer, and wherein the at least one memory and stored computer program code are configured, with the at least one processor, to cause the apparatus to combine the first and second user interface information by overlaying the overlay user interface layer on the base user interface layer.

11. The apparatus of claim 9, wherein the second user interface information is generated by the server application based at least in part on data provided to the server apparatus by the apparatus.

12. The apparatus of claim 11, wherein the data provided to the server apparatus comprises one or more of sensory data captured by the apparatus, video data, audio data, image data, or an indication of a user interaction with a user interface of the apparatus.

13. The apparatus of claim 11, wherein the data provided to the server apparatus comprises preprocessed data generated by preprocessing original data, the preprocessed data comprising a reduced size representation of the original data.

14. The apparatus of claim 9, wherein the first and second user interface information comprise one or more of visual information, audio information, or haptic feedback information.

15. The apparatus of claim 9, wherein the apparatus further comprises or is in communication with a user interface, and wherein the at least one memory and stored computer program code are configured, with the at least one processor, to cause the apparatus to cause the integrated application user interface to be output by the user interface.

16. The apparatus of claim 9, wherein the first user interface information comprises image data and the second user interface information comprises identification information identifying content of the image data, and wherein the at least one memory and stored computer program code are configured, with the at least one processor, to further cause the apparatus to:
cause a representation of the image data to be provided to the server apparatus to enable the server application to derive the identification information; and
combine the first and second user information by overlaying the identification information on the image data.

17. The apparatus of claim 9, wherein the apparatus comprises or is embodied on a mobile phone, the mobile phone comprising user interface circuitry and user interface software stored on one or more of the at least one memory; wherein the user interface circuitry and user interface software are configured to:
facilitate user control of at least some functions of the mobile phone through use of a display; and
cause at least a portion of a user interface of the mobile phone to be displayed on the display to facilitate user control of at least some functions of the mobile phone.

18. A computer program product comprising at least one computer-readable storage medium having computer-readable program instructions stored therein, the computer-readable program instructions comprising:
program instructions configured to obtain, in a client apparatus, first user interface information generated by a client application residing on the client apparatus;
program instructions configured to obtain, in the client apparatus, second user interface information generated by a server application residing on a remote server apparatus; and
program instructions configured to combine the first and second user interface information to generate an integrated application user interface.

19. The computer program product of claim 18, wherein the first user interface information comprises a base user interface layer and the second user interface information comprises an overlay user interface layer, and wherein the program instructions configured to combine the first and second user interface information comprise program instructions configured to overlay the overlay user interface layer on the base user interface layer.

20. The computer program product of claim 18, wherein the second user interface information is generated by the server application based at least in part on data provided to the server apparatus by the client apparatus.
